(19) United States
(12) Patent Application Publication
(10) Pub. No.: US 2016/0071417 A1
(43) Pub. Date: Mar. 10, 2016

(54) INTER-VEHICLE COLLISION AVOIDANCE SYSTEM

(71) Applicants: Hyundai America Technical Center, Inc., Superior Township, MI (US); Hyundai Motor Company, Seoul (KR); Kia Motors Corporation, Seoul (KR)

(72) Inventors: Allan Lewis, Windsor (CA); Mohammad Naserian, Windsor (CA)

(21) Appl. No.: 14/482,267

(22) Filed: Sep. 10, 2014

(51) Int. Cl. G08G 1/16

(52) U.S. Cl. CPC G08G 1/163; G08G 1/166

(57) ABSTRACT

In one embodiment, a controller of a local vehicle receives data from a remote vehicle that indicates a location and direction of travel of a remote vehicle. The controller determines a roadway path of travel of the remote vehicle using map data and the data received from the remote vehicle. The controller determines a roadway path of travel of the local vehicle using the map data and data indicative of a location and direction of travel of the local vehicle. The controller also determines whether the roadway path of travel of the local vehicle and the roadway path of travel of the remote vehicle intersect. The controller further provides an alert, in response to determining that the roadway path of travel of the local vehicle and the roadway path of travel of the remote vehicle intersect.

### BACKGROUND

(a) Technical Field

The present disclosure generally relates to a vehicular collision avoidance system. In particular, systems and methods are disclosed herein that incorporate vehicle to vehicle (V2V) communications and map data, to identify potential inter-vehicle collisions beforehand.

(b) Background Art

Ensuring passenger safety during a vehicle collision has become an area of increased interest in recent years. Nearly every system of a modern vehicle is designed with this goal in mind. For example, many modern automobiles include airbag systems that, when a collision is detected, deploy airbags within the passenger compartment to cushion the passengers from the impact. In another example, many modern vehicle frames are built with “crumple zones” that help to absorb the impact forces of a collision before reaching the passengers of the vehicle.

In contrast to safety systems that seek to ensure passenger safety during a collision, a new area of interest has focused on mechanisms that operate to avoid the collision altogether. For example, some vehicles are now equipped with radar and/or cameras that monitor the path of a vehicle for upcoming obstacles. If an obstacle is detected within a certain range of the vehicle, such systems may provide an alert to a driver, apply the brakes of the vehicle automatically, or take other preventative measures to help avoid collision with the obstacle. However, such systems are typically limited in their coverage of the vehicle. For example, a forward-facing collision avoidance system may not be able to detect an impending side-impact collision at an intersection. In addition, many current collision avoidance systems lack a sufficient balance between generating too few alerts (e.g., not reporting on a potential collision) and generating too many alerts, thereby desensitizing the driver to the alert mechanism.

In order to solve the problems in the related art, there is a demand for the development of collision avoidance systems that provide greater ranges of coverage around a vehicle as well as increasing the relevancy of collision alerts provided to a driver.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides systems and methods for avoiding inter-vehicle collisions. In particular, a collision avoidance system is provided that uses vehicle to vehicle (V2V) communications and map data to detect potential collisions.

In one embodiment, a controller of a local vehicle receives data from a remote vehicle that indicates a location and direction of travel of a remote vehicle. The controller determines a roadway path of travel of the remote vehicle using map data and the data received from the remote vehicle. The controller determines a roadway path of travel of the local vehicle using the map data and data indicative of a location and direction of travel of the local vehicle. The controller also determines whether the roadway path of travel of the local vehicle and the roadway path of travel of the remote vehicle intersect. The controller further provides an alert, in response to determining that the roadway path of travel of the local vehicle and the roadway path of travel of the remote vehicle intersect.

According to some aspects, the controller may determine whether the roadway path of travel of the local vehicle and the roadway path of travel of the remote vehicle intersect by identifying a non-intersecting roadway feature from the map data in the roadway paths of travel of the local and remote vehicle and suppressing the alert, in response to identifying the non-intersecting roadway feature. In a further aspect, the non-intersecting roadway feature may include at least one of: a roadway overpass, a roadway cloverleaf, a roadway curvature, a tiered bridge, or a roundabout. In a further aspect, the data indicative of a location and direction of travel of the local vehicle may include global positioning system (GPS) data. The intersecting roadway paths of travel of the local and remote vehicles may include at least one of: a sloped entry intersection, a roadway curvature, or a sloped roadway in which the remote vehicle is stopped. In some cases, the data indicative of a location and direction of travel of the local vehicle may be received by the controller via an Advanced Driver Assistance Systems Interface Specifications (ADASIS) message.

In another aspect, the controller may identify an upcoming built-up area associated with the roadway path of travel of the local vehicle and, in response, increase a transmission power used to transmit the data regarding the location and direction of travel of the local vehicle to the remote vehicle. In yet a further aspect, the controller may determine an estimated time to crash between the local and remote vehicles. In another aspect, the controller may provide the alert to at least one of: an electronic display, a braking system of the local vehicle, or a steering system of the local vehicle.

In another embodiment, a system is disclosed that includes a processor and a memory configured to store a process executable by the processor. When executed by the processor, the process is operable to receive data from a remote vehicle that indicates a location and direction of travel of a remote vehicle and to determine a roadway path of travel of the remote vehicle using map data and the data received from the remote vehicle. The process when executed is also operable to determine a roadway path of travel of a local vehicle using the map data and data indicative of a location and direction of travel of the local vehicle. The process when executed is further operable to determine whether the roadway path of travel of the local vehicle and the roadway path of travel of the remote vehicle intersect. The process when executed is additionally operable to provide an alert, in response to determining that the roadway path of travel of the local vehicle and the roadway path of travel of the remote vehicle intersect.

In another embodiment, a tangible, non-transitory, computer-readable media having software encoded thereon. The software when executed by a processor is operable to receive data from a remote vehicle that indicates a location and direction of travel of a remote vehicle and to determine a roadway path of travel of the remote vehicle using map data and the data received from the remote vehicle. When executed by the processor the software is also operable to determine a roadway path of travel of a local vehicle using the map data and data indicative of a location and direction of travel of the local vehicle and to determine whether the roadway path of travel of the local vehicle and the roadway path of travel of the remote vehicle intersect. When executed by the processor, the software is additionally operable to provide an alert, in response to determining that the roadway path of travel of the local vehicle and the roadway path of travel of the remote vehicle intersect.

Advantageously, the systems and methods described herein provide for inter-vehicle collision avoidance with increased alert relevancy.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is a diagram illustrating a vehicle to vehicle (V2V) communication system;

FIG. 2 is a diagram illustrating example coordinates used by an inter-vehicle collision avoidance system;

FIG. 3 is a diagram illustrating an example roadway feature;

FIG. 4 is a block diagram of a collision avoidance system controller;

FIG. 5 is a flow diagram of a procedure for detecting a potential collision;

FIG. 6 is a flow diagram of a procedure for suppressing a collision alert;

FIG. 7 is a diagram illustrating an upcoming built-up area along a roadway path;

FIG. 8 is a flow diagram of a procedure for adjusting a V2V transmission power; and

FIGS. 9A-9C are flow diagrams illustrating a procedure for avoiding an inter-vehicle collision.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present disclosure will be described so as to be easily embodied by those skilled in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that some of the methods may be executed by at least one controller. The term controller refers to a hardware device that includes a memory and a processor configured to execute one or more machine instructions that correspond to processing steps. The memory is configured to store machine instructions and the processor is specifically configured to execute said instructions to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention provides an inter-vehicle collision avoidance system that makes use of vehicle to vehicle (V2V) communications between the vehicles, to alert nearby vehicles as to the location and direction of travel of a vehicle. The collision avoidance system may use the V2V communications in conjunction with map data to determine roadway paths of travel of the local and remote vehicle. If the roadway paths of travel intersect, the collision avoidance system may take collision avoidance measures, such as providing an alert. Notably, the collision avoidance system may suppress alerts when non-intersecting roadway features are detected between the vehicles. For example, the system may suppress alerts when the vehicles otherwise appear to be headed for a collision but will not actually meet due to a roadway condition (e.g., one of the vehicles is headed along an overpass, etc.). In further cases, the features along the roadway paths of travel of the vehicle may be used to adjust the V2V transmission power, such as when upcoming structures are detected.

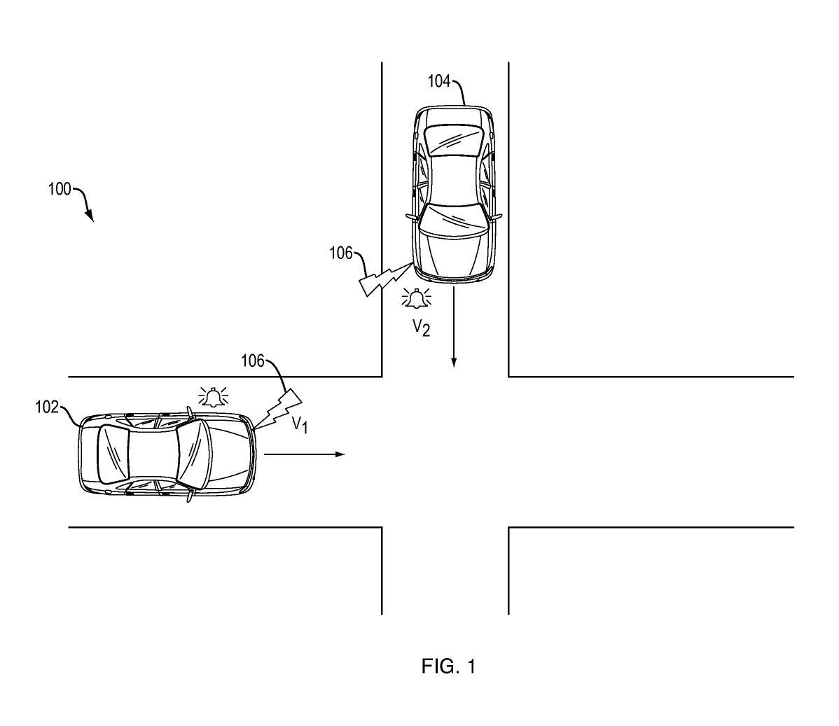

Referring now to FIG. 1, an example V2V collision avoidance system 100 is shown, according to various embodiments. As shown, a first vehicle 102 may be traveling along a first direction of travel (e.g., along a first vector of travel V₁) and a second vehicle 104 may be traveling along a second direction of travel (e.g., along a second vector of travel V₂). In various embodiments herein, one or both of vehicles 102-104 may transmit V2V communications 106 that indicate each respective vehicle's current location, direction of travel (e.g., V₁ or V₂), and/or other information (e.g., whether the vehicle's turn signal has been activated, etc.). In some cases, communications 106 may also include a rate of travel of the respective vehicles. In other embodiments, the rate of travel of one of vehicles 102-104 may be determined by the other one of vehicles 102-104 based on communications 106 (e.g., by dividing a difference in location coordinates by the a difference in time, etc.).

Illustratively, and in various embodiments, communications 106 may be simplified communications that do not include predicted path data regarding the respective predicted paths of travel of vehicles 102-104. Said differently, communications 106 may not include any path predictions regarding the respective vehicles 102-104, allowing the message transmission time and amount of transmitted data to be kept to a minimum between vehicles 102-104. For example, communications 106 may simply include the two or three dimensional location coordinates of a given vehicle 102-104 and/or the two or three dimensional vector parameters of the vehicle's direction of travel.

In response to receiving a communication 106 from vehicle 104, vehicle 102 may determine whether or not an inter-vehicle collision between vehicles 102-104 is likely. For example, if the relative speeds and directions of travel of vehicles 102-104 is determined by vehicle 102 to indicate that vehicles 102-104 will be located at the same location at the same time, vehicle 102 may determine that an inter-vehicle collision with vehicle 104 is impending. In response, vehicle 102 may initiate any number of avoidance measures such as providing an alert to a user interface device (e.g., an electronic display, a speaker, etc.), to alert the driver of vehicle 102 to the potential collision. In other embodiments, the alert may be provided to a system of vehicle 102 such as a steering system (e.g., to change the direction of travel of vehicle 102), a braking system (e.g., to alter the rate of travel of vehicle 102), an electronic throttle system (e.g., to reduce the amount of power provided to the wheels of vehicle 102), or the like.

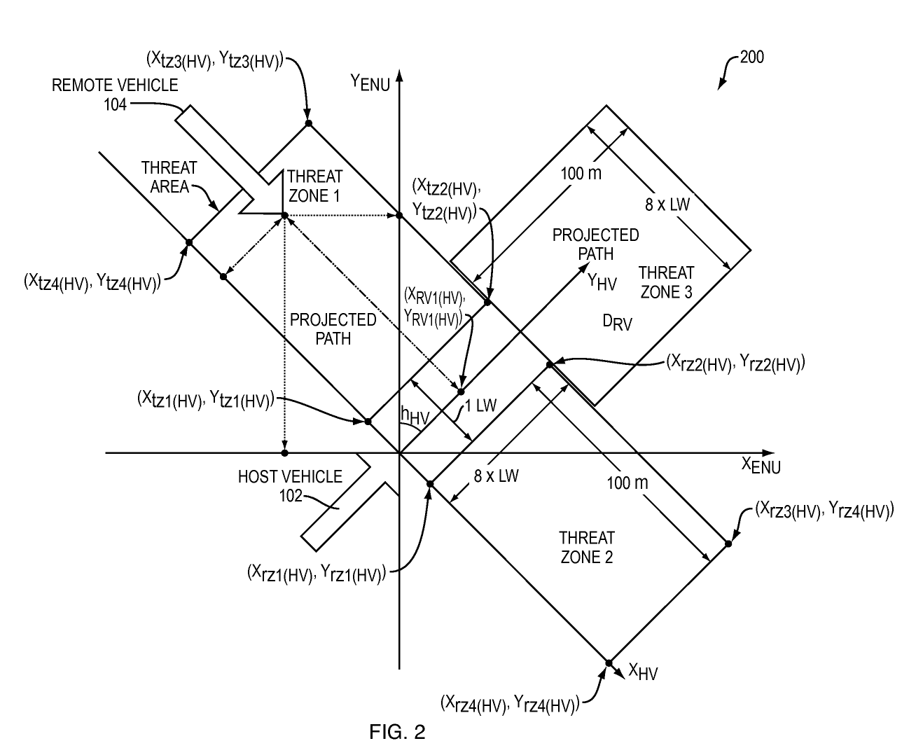

Example coordinates for an inter-vehicle collision avoidance system are shown in FIG. 2, in various embodiments. For example, as shown, the onboard collision avoidance system of host/local vehicle 102 may identify one or more threat zones 200 (denoted tz₁, tz₂, etc.) relative to remote vehicle 104 based on the relative locations of vehicles 102-104. For example, the area of a given threat zone may be defined by a preset length (e.g., 100 meters or another distance) and a preset width that is a function of the lane width. For example, threat zone 3 (e.g., an oncoming threat zone) may have a width equal to eight times the lane width of the lane in which vehicle 102 is traveling and may be defined relative to host vehicle (hv)/local vehicle 102. Conversely, the projected path of the remote vehicle (rv) 104 may be represented in the same coordinate system as that of vehicle 102.

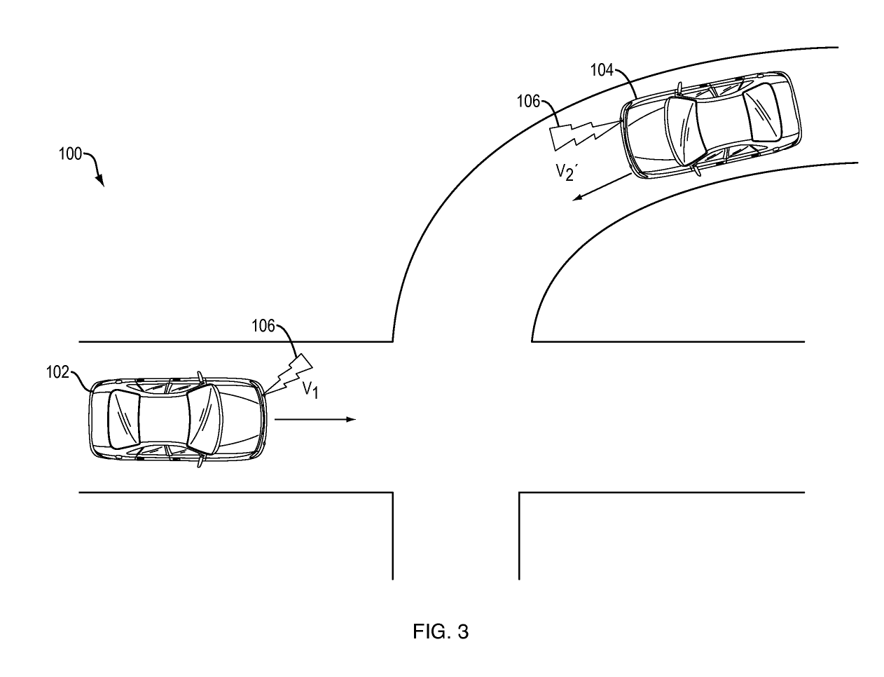

Referring now to FIG. 3, a diagram illustrating an example roadway feature is shown, in various embodiments. A number of roadway conditions may arise that could cause an inter-vehicle collision avoidance system to either over report alerts (e.g., generate false alarms) or under report alerts (e.g., fail to detect a potential threat to the vehicle). For example, continuing the example of FIG. 1, assume that vehicle 102 approaches the intersection along a roadway curvature, as opposed to the perpendicular roadway depicted in FIG. 1. In such a case, the reported direction of travel by vehicle 104 in communication 106 may indicate a different travel vector V₂′ than vector V₂ depicted in FIG. 1. Thus, the threat zones 200 shown in FIG. 2, as well as the calculations used by vehicle 102 to identify a potential collision with vehicle 104 may not accurately reflect the potential risks to vehicle 102, if travel vector V₂′ alone is used by vehicle 102 to predict the future path of travel of vehicle 104. Accordingly, in this situation, the collision avoidance system of vehicle 102 may fail to recognize the impending threat presented by vehicle 104 approaching the same intersection as vehicle 102.

Example roadway conditions that may lead to an undetected threat may include, but are not limited to, a sloped or curved entry intersection, a sloped roadway in which the remote vehicle is either stopped or traveling at a significantly slow velocity than the local vehicle, a curved roadway, or the like. Conversely, example roadway conditions that may lead to false alarms may include, but are not limited to, certain roadway curvatures in which the roadway do not actually intersect, cloverleafs, overpasses, tunnels, roundabouts, rotaries, tiered bridges, or the like.

According to various embodiments, vehicle 102 may use map data to augment its collision detection system. In particular, vehicle 102 may combine the data in communication 106 from remote vehicle 104 (e.g., the location and/or direction of travel of vehicle 104) with map data, to determine a roadway path of travel of vehicle 104. For example, based on the map data and the direction of travel of vehicle 104, vehicle 102 may determine that both vehicles 102-104 are approaching the same intersection.

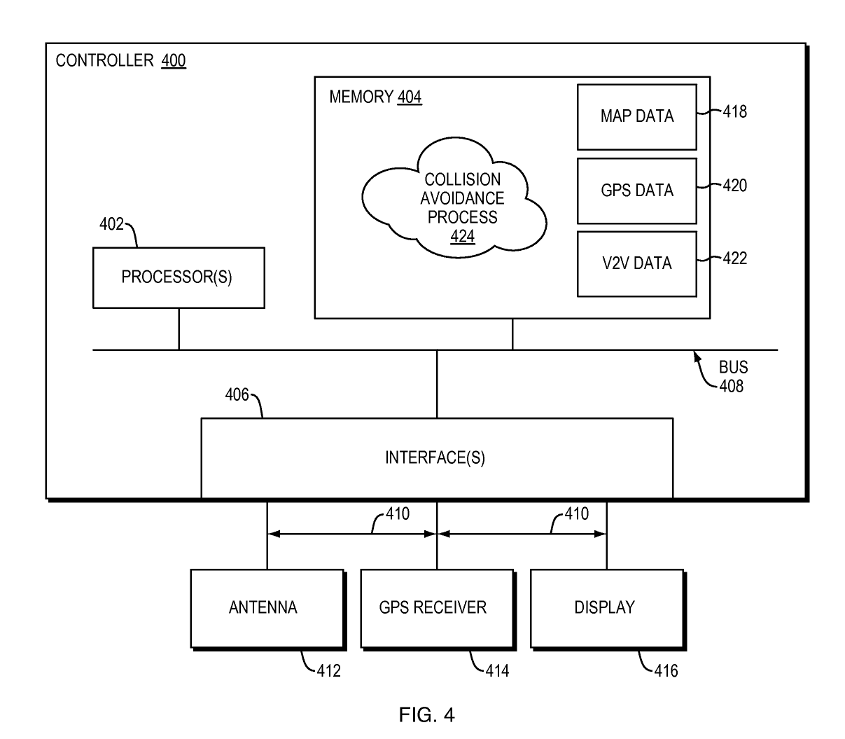

Referring now to FIG. 4, a block diagram of a collision avoidance system controller 400 is shown, according to various embodiments. Controller 400 may be local to a vehicle (e.g., vehicle 102) and, in general, operate to detect and prevent inter-vehicle collisions between the local vehicle and a remote vehicle (e.g., vehicle 104). In various embodiments, controller 400 may include one or more processors 402, one or more memory devices 404, and one or more communication interfaces 406 that are interconnected by a system bus 408.

Interface(s) 406 contain the mechanical, electrical, and signaling circuitry for communicating data with other devices and systems via connections 410 that may be wired or wireless. In one embodiment, connections 410 may be part of a CAN bus that relays messages throughout the vehicle. In other embodiments, different protocols and/or communication strategies may be used by interfaces 406 to communicate within the vehicle.

The memory 404 comprises a plurality of storage locations that store data 418-422 and are addressable by the processor(s) 402 and the network interface(s) 410 for storing software programs and data structures associated with the embodiments described herein. The processor(s) 402 may comprise hardware elements or hardware logic adapted to execute the software programs and manipulate the stored data. Memory 404 may also store a collision avoidance process 424 that, when executed by processor(s) 402 causes processor(s) 402 to perform the operations described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various embodiments, controller 400 may be in communication with an antenna 412 configured to receive and/or transmit V2V data between the local and remote vehicles. As shown, controller 400 may store V2V data 422 received from one or more remote vehicles. As noted above, data 422 may indicate a location and/or direction of travel of a remote vehicle.

Controller 400 may also be in communication with a GPS receiver 414 that receives and provides GPS data 420 to controller 400. GPS data 420 may include, for example, coordinate data and other information that indicates the current location and/or direction of travel of the local vehicle (e.g., the vehicle on which controller 400 resides). In some embodiments, controller 400 may also store map data 418 (e.g., roadway data) that may be preloaded into memory 404, received via GPS receiver 414 or another storage location, or combinations thereof. In one embodiment, GPS receiver 414 may be part of a hardware module that provides messages to controller 400 using the Advanced Driver Assistance System Interface Specification (ADASIS) protocol format. As would be appreciated, such ADASIS messages may include various information such as the current location of the local vehicle, path information regarding one or more roadway paths, path offsets, data indicative of upcoming structures (e.g., buildings, man-made structures, natural structures), etc.

Collision avoidance process 424 may analyze data 418-422 to determine a roadway path of travel of the local vehicle and a roadway path of travel of the remote vehicle. In addition, process 424 may compare the roadway paths of travel of the two vehicles to determine whether the two paths intersect. If so, process 244 may determine whether a potential collision is likely based on the current locations, movement, etc. of the two vehicles. For example, if both vehicles are approaching the same intersection at the same time and from comparable distances, process 424 may determine that a potential collision condition exists. In response, process 424 may provide an alert to a user interface device such as display 416, another user interface (e.g., a speaker), and/or other vehicle systems such as a steering system (e.g., to force the local vehicle to change direction), braking system (e.g., to force the local vehicle to change its rate of travel), or the like. However, if map data 418 indicates that the vehicles are approaching a non-overlapping roadway feature, process 424 may suppress the generation of a collision alert. For example, if the two vehicles are otherwise headed on a collision course based on their current directions of movement, but their respective roadways do not intersect (e.g., one roadway dips and passes below the other roadway), process 424 may suppress the generation of an alert until an actual collision is detected.

In some embodiments, collision avoidance process 424 may adjust the transmission strength of V2V communications sent via antenna 412, when process 424 determines that a potential interference condition is present or impending. For example, if the signal strength received from a remote vehicle is below a threshold value relative to the distance between the two vehicles, process 424 may increase the transmission power sent to antenna 412. In another embodiment, process 424 may analyze buildup data (e.g., data indicating upcoming buildings, etc.), to adjust the power levels of antenna 412.

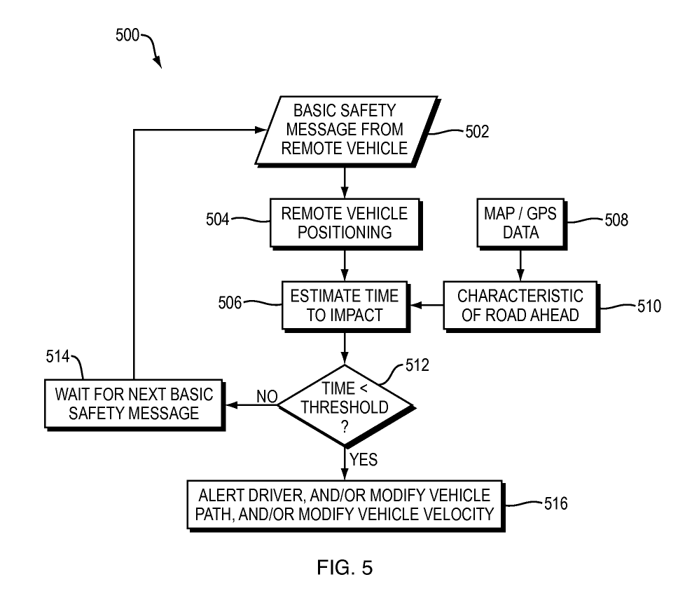

Referring now to FIG. 5, a flow diagram of a procedure 500 is shown for detecting a potential collision, according to various embodiments. In general, procedure 500 may be used to mitigate collision situations that may be otherwise missed based on the travel vectors of the two vehicles. At step 502, a collision avoidance system of the local vehicle receives a basic safety message from the remote vehicle. For example, as shown above in FIG. 1, vehicle 102 may receive a V2V communication from vehicle 104 that indicates the location and/or direction of travel of vehicle 104.

At step 504, the collision avoidance system of the local vehicle determines potential positions/locations of the remote vehicle. In other words, the local vehicle may use the received V2V data to predict a future location of the remote vehicle and/or path of travel of the vehicle.

At step 508, the collision avoidance system may receive map and/or GPS data regarding the current location of the local vehicle. For example, in one embodiment, the collision avoidance system may receive ADASIS data.

At step 510, the collision avoidance system uses the map and/or GPS data to determine one or more characteristics of the roadway ahead of the local vehicle. For example, the collision avoidance system may identify any roadway conditions that may cause either or both vehicles to change their respective directions of travel at some point in the future. For example, the collision avoidance system may determine that while both vehicles are currently headed along vectors that do not currently intersect, an upcoming curvature in the roadway will cause the vectors to intersect at some time in the future.

At step 506, the collision avoidance system may estimate a time to impact between the two vehicles. In particular, the local vehicle may use the road characteristics identified in step 510 to predict the future motion vectors associated with the local and remote vehicles. Based on these vectors and the rates of motion of the vehicles, the local collision avoidance system may estimate when an impact is likely to occur.

At step 512, the collision avoidance system determines whether the time to impact from step 506 is less than a defined threshold. If it is not, procedure 500 may continue on to step 514 where the system waits for the next message from the remote vehicle in step 514. However, if the time to impact is below the threshold, procedure may continue on to step 516 where the collision avoidance system may take any number of actions to prevent the collision. For example, the system may provide an alert to a user interface device, a steering system of the local vehicle, or a braking system of the vehicle.

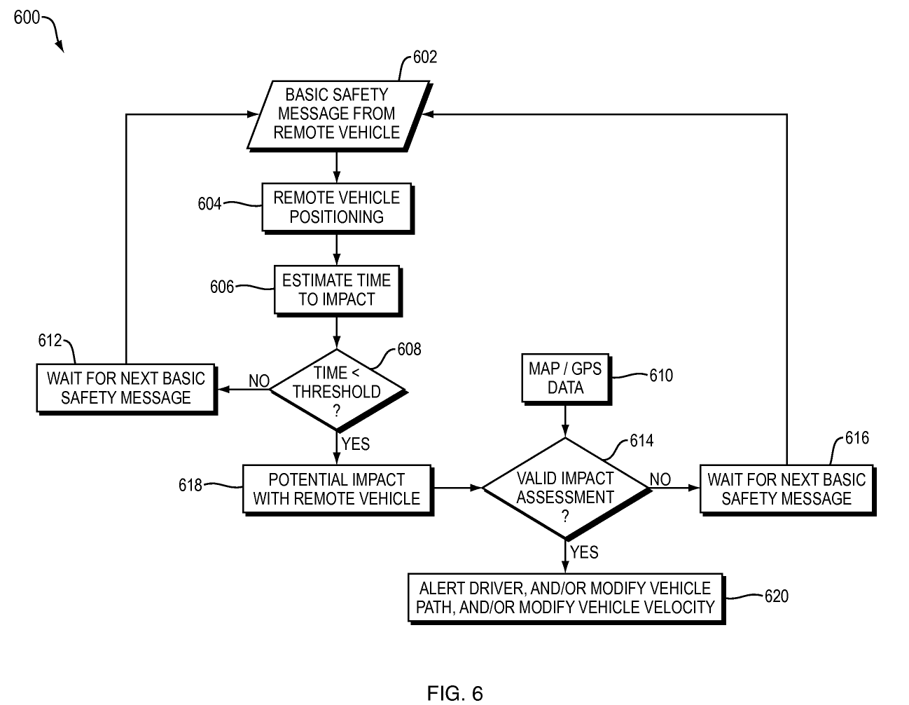

FIG. 6 is a flow diagram of a procedure 600 for suppressing a collision alert, according to various embodiments. Like procedure 500, procedure 600 may be performed by a collision avoidance system of a local vehicle. Steps 602-608 may be performed in a similar manner to steps 502-512 shown in FIG. 5. In particular, the local collision avoidance system may receive a V2V safety message from a remove vehicle (step 602), determine the path of travel of the remote vehicle (step 604), estimate a time to impact between the two vehicles (step 606), and determine whether the time to impact is below a threshold amount of time. If not, procedure 600 may continue on to step 612 where, like in step 514, the local vehicle may wait for another message from the remote vehicle before proceeding. However, if the time to impact is below the threshold amount of time, procedure 600 may proceed to step 608 where the collision avoidance system determines that a potential impact between vehicles is impending.

At step 610, the collision avoidance system may receive map and/or GPS data and, at step 614, use the data to determine the roadway paths of travel of the two vehicles and decide whether or not the impact assessment of step 618 is valid. For example, if the roadway paths of travel of the two vehicles meet at a non-intersecting roadway feature, the system may proceed to step 616 where it waits for another message from the remote vehicle. However, if the impact assessment is valid (e.g., the roadway paths of travel genuinely intersect and the vehicles' directions of travel indicate an impending collision), procedure 600 may continue on to step 620 where the system takes corrective measures, similar to that of step 516 in procedure 500.

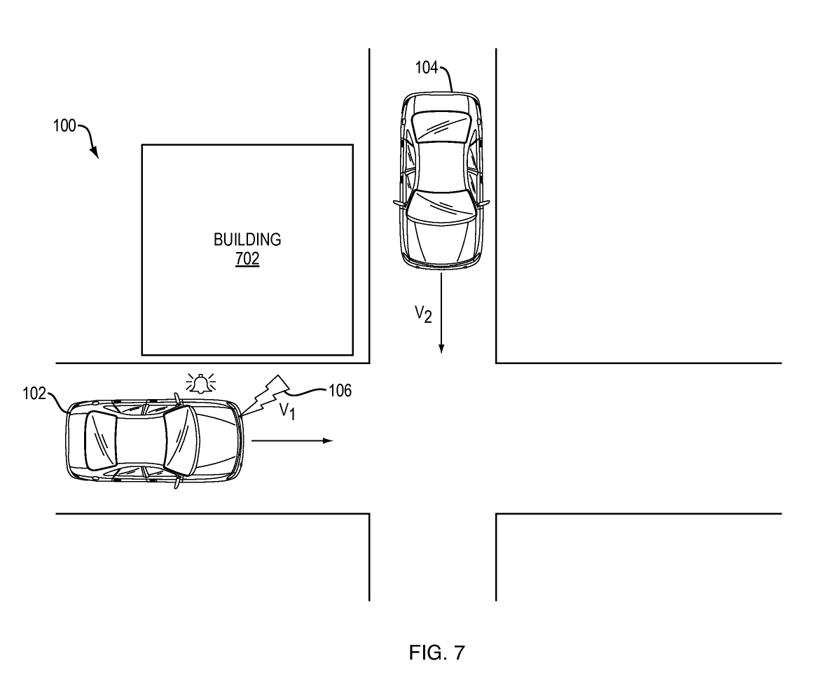

Referring now to FIG. 7, a diagram of an upcoming built-up area along a roadway path is shown, according to various embodiments. Continuing the example of FIG. 1, assume that a building 702 is currently between vehicles 702 or will be, based on the map data used by the respective systems of vehicles 102-104. In such a situation, building 702 may increase the amount of packet loss of communications 106 as vehicles 102-104 approach the intersection. According to various embodiments, in such a case, vehicle 102 may increase the transmission power used for communications 106, to increase the potential of vehicle 104 receiving the communication.

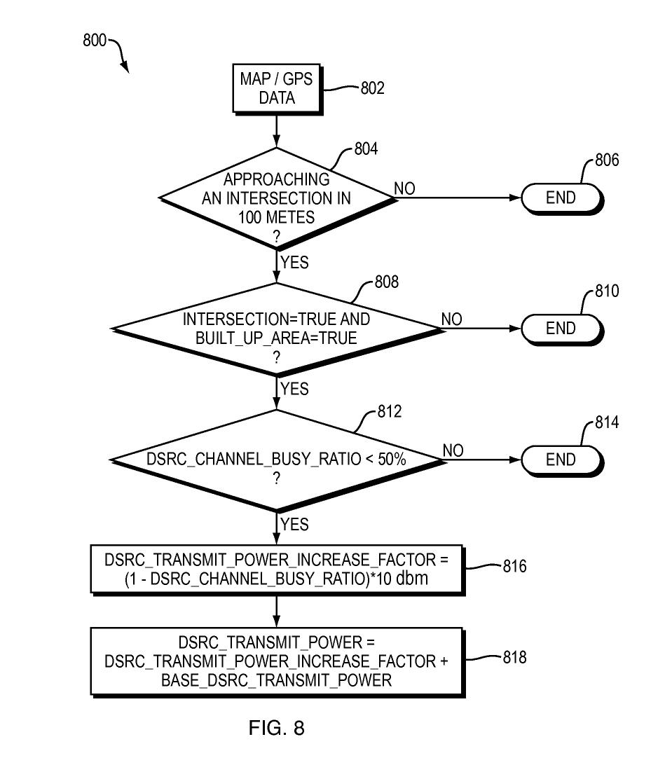

FIG. 8 is a flow diagram of a procedure 800 for adjusting a V2V transmission power, according to various embodiments. At step 802, the collision avoidance system receives map and/or GPS data, as detailed above. For example, the collision avoidance system may receive such information within an ADASIS message from a GPS-equipped module on the local vehicle. The system then makes any number of decisions regarding the current and future V2V communication conditions of the vehicle. For example, the system may determine whether the local vehicle is approaching an intersection (step 804), whether the intersection is a built-up area (e.g., as determined by a corresponding flag set in an ADASIS messages) (step 808), and/or determine whether the dedicated short range communications (DSRC) channel is busy less than half of the time (812). If any of these conditions are not met, procedure 800 may end at corresponding steps 806, 810, or 814.

If the conditions in steps 804, 808, and 812 are met, procedure 800 may proceed to step 816 where the system determines a transmission factor by which the transmission power of the V2V communications is to be increased. In one embodiment, this factor may be calculated as follows:

DSRC_Transmit_Power_Increase_Factor=(1−DSRC_Channel_Busy_Ratio)*10 dbm

where DSRC_Transmit_Power_Increase_Factor is the transmission increase factor and DSCRC_Channel_Busy_Ratio is the ratio of channel usage by the communications.

At step 818, the system uses the power increase factor to determine a new transmit power by multiplying the current/base transmit power (e.g., Base_DSRC_Transmit_Power) by the increase factor calculated in step 816.

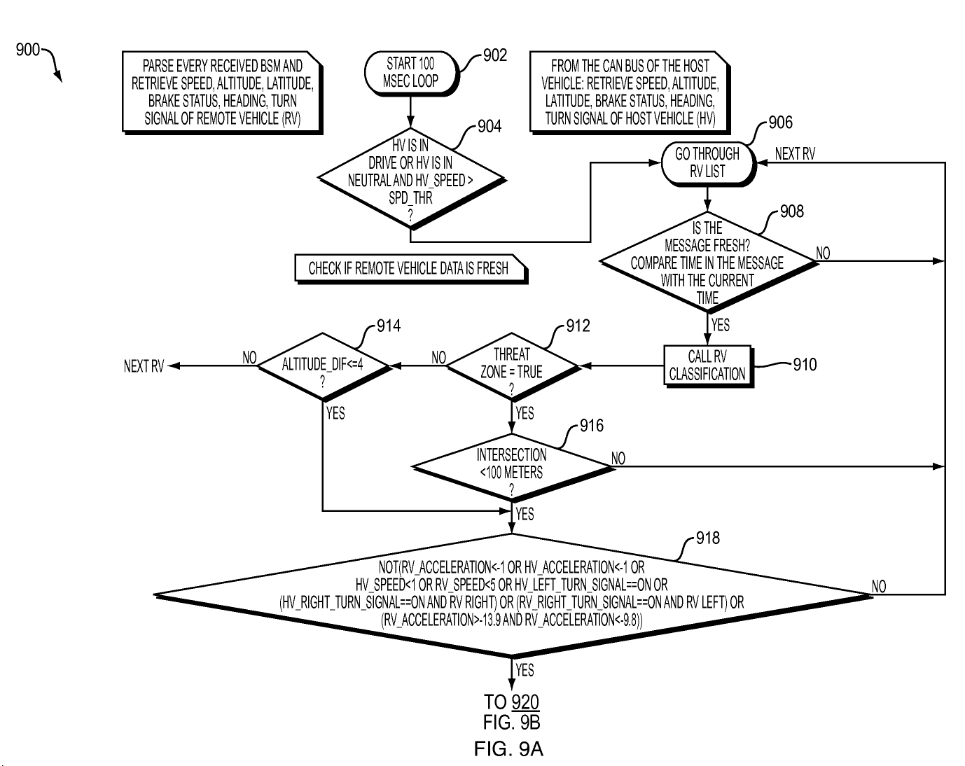

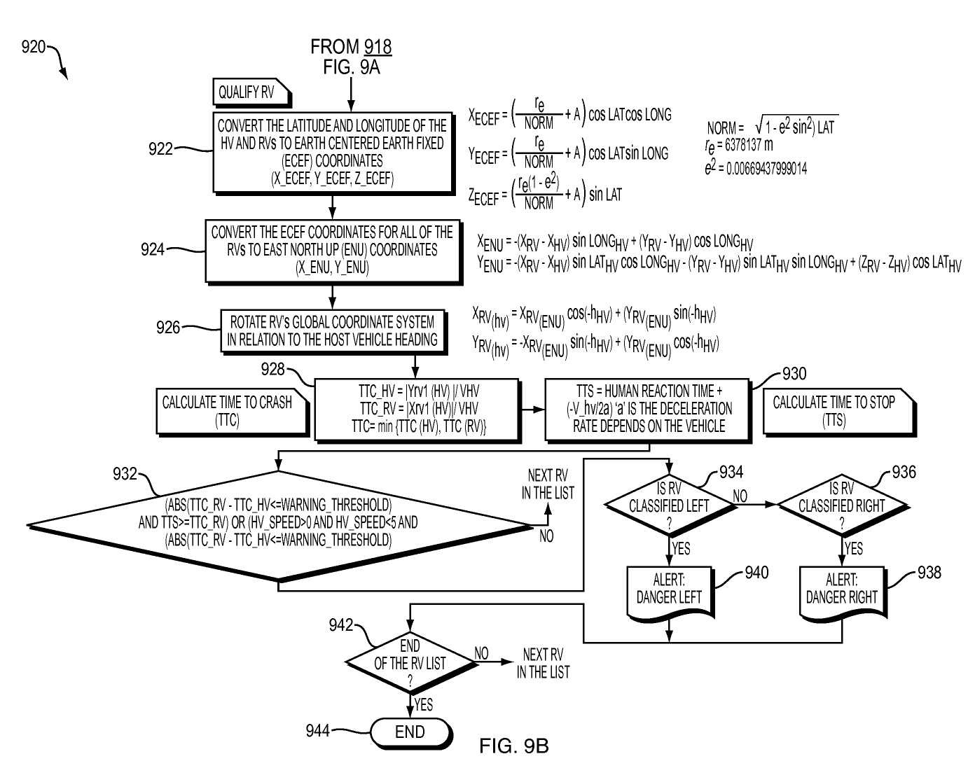

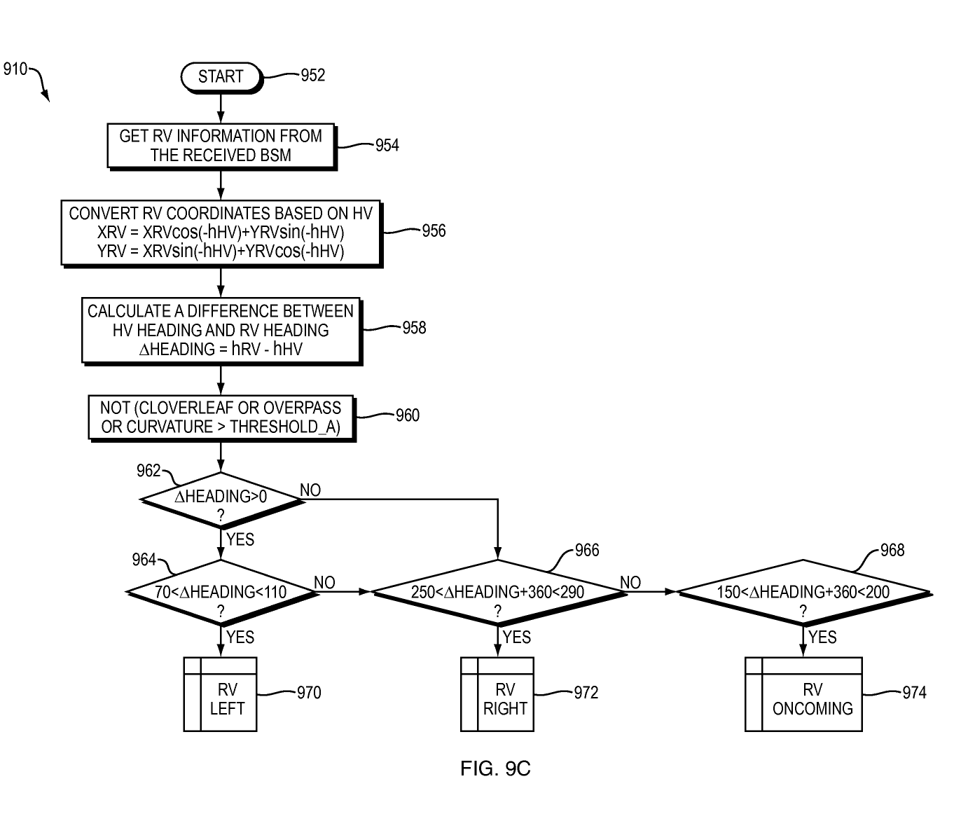

Referring now to FIGS. 9A-9C, flow diagrams are shown illustrating a procedure 900 for avoiding an inter-vehicle collision. At step 902, the collision avoidance system may begin a loop that processes V2V communication messages from remote vehicles and data available to the local vehicle. For example, such information may be analyzed periodically as part of the loop every 100 milliseconds (ms). Other loop periods may be used in other embodiments (e.g., every 10 ms, every 50 ms, etc.). Example data that may be included in V2V basic safety message may include, but are not limited to, the speed, altitude, latitude, brake status, heading, and/or turn signal information regarding the remote vehicle. Similar information may also be received by the collision avoidance system regarding the local vehicle itself (e.g., from other vehicle systems, such as an ADASIS module, etc.).

At step 904, a determination is made as to whether or not the local/host vehicle (HV) is in motion. For example, the collision avoidance system may use the data regarding the host vehicle to determine whether the host vehicle is in drive or neutral and its speed is greater than a threshold parameter. If any these conditions are met, procedure 900 may proceed to step 906. Otherwise, procedure 900 may wait until the next loop frame and repeat step 904.

At step 906, the collision avoidance system may identify a list of one or more remote vehicles (RVs). Such identification may be based on, for example, any V2V communications received by the local/host vehicle from any other remote vehicles in the area.

At step 908, the collision avoidance system determines whether a V2V message received from a particular remote vehicle is fresh. For example, the collision avoidance system may compare a timestamp included in the V2V message or a locally-generated timestamp corresponding to the receipt of the V2V message, to determine how much time has elapsed since the timestamp. If the difference between the timestamp and the current time exceeds a time threshold parameter, the V2V message may be considered stale and procedure 900 may return to step 906 to analyze a message for the next remote vehicle in the list, if available. However, if the message is considered fresh, procedure 900 may proceed to step 910.

At step 910, the collision avoidance system may classify the potential threat posed by the remove vehicle. A detailed flow diagram of the substeps of this classification is shown in FIG. 9C. As shown, in substep 954, the collision avoidance system may analyze the V2V basic safety message (BSM) received from the remote vehicle, to determine the location coordinates, etc. of the remote vehicle.

At substep 954, the collision avoidance system may convert the coordinates of the remote vehicle into that of the local/host vehicle. For example, the system may perform the following calculations to convert the x-axis and y-axis coordinates of the remote vehicle into that of the local/host vehicle as follows:

XRV=XRV cos(−hHV)+YRV sin(−hHV)

YRV=XRV sin(−hHV)+YRV cos(−hHV)

where hHV is the heading of the local/host vehicle.

At substep 958, the system may determine a difference between the headings of the local/host vehicle and the remote vehicle. For example, collision avoidance system may determine the heading difference using the converted coordinates in step 956 to determine the difference in headings of the two vehicles.

At substep 960, the collision avoidance system may determine whether there are any roadway characteristics that may affect the assessment of the heads of the two vehicles. In one embodiment, the collision avoidance system may identify whether there are any non-intersecting roadway features that may affect any heading comparisons between the two vehicles (e.g., while the headings appear to present a danger, the roadway features are such that no such danger actually exists). For example, the collision avoidance system may compare map data to the locations and headings of the vehicles, to determine whether the vehicles are approaching a cloverleaf, overpass, curvature, or any other roadway feature that indicates that the vehicles' headings will not actually overlap. Said differently, the collision avoidance system may determine roadway paths of travel of the two vehicles, to determine whether an actual threat of collision exists. If such a non-intersecting roadway feature is detected, the system may suppress any alerts and analyze the next remote vehicle.

At substep 962, if the collision avoidance system determines that the roadway paths of the two vehicles intersect, the system may analyze the heading difference between the two vehicles determined in substep 958. If the heading difference is negative (e.g., relative to the coordinate system shown in FIG. 2), the collision avoidance system may classify the remote vehicle as being within the left threat zone of the local vehicle (step 970). If the heading different is positive, a decision may be made at step 966 as to whether or not the heading difference plus 360° is between 250° and 290°. If so, the remote vehicle may be classified as being within the right-hand threat zone of the local vehicle (step 972). Similarly, the collision avoidance system may determine whether or not the heading difference plus 360° is between 150° and 200° (step 968). If so, the system may classify the remote vehicle as being within an oncoming threat zone (step 974).

Referring again to FIG. 9A, procedure 900 may continue on to step 912 where a decision is made as to whether or not the remote vehicle is within a threat zone of the local/host vehicle (e.g., within a left, right, or oncoming threat zone). If so, procedure 900 continues on to step 916 where the distance to the intersection is evaluated. If not, procedure 900 continues on to step 914.

At step 916, the collision avoidance system may determine whether the distance to the intersection is greater than a threshold amount (e.g., 100 meters, etc.). If so, procedure 900 may return to step 906 an analyze the next remote vehicle, if any. If the distance to intersection is less than the threshold, procedure 916 continues on to step 918.

At step 914, the system may assess whether or not the altitude difference between the two vehicles is less than or equal to a threshold amount. Notably, such altitude information may be available as part of GPS or map data associated with each vehicle. If the altitude difference is less than the threshold, procedure 900 continues on to step 918. Otherwise, procedure 900 returns to step 906 and assesses the next remote vehicle, if any.

At step 918, the collision avoidance system may filter out situations in which the remote vehicle is located within a threat zone of the local/host vehicle, but do not pose an actual threat to the local vehicle. For example, the collision avoidance system may filter out situations in which the remote vehicle is moving away from a threat zone of the local vehicle, the local and/or remote vehicle is turning (e.g., based on the vehicle's turn signal being activated), or the like. If any such conditions exist, procedure 900 may return to step 906 and the collision avoidance system may analyze another remote vehicle, if available. Otherwise, procedure 900 continues on to sub-procedure 920.

Referring now to FIG. 9B, the collision avoidance system may perform sub-procedure 920 if the remote vehicle is determined to be a potential threat. At step 922, the location coordinates of the host and remote vehicles are converted into an Earth Centered Earth Fixed (ECEF) coordinate system. At step 924, the ECEF coordinates are then shifted to East North Up (ENU) coordinates. Finally, the remote vehicle's global coordinate system is rotated in relation to the heading of the host vehicle.

At step 928, the collision avoidance system may use the converted coordinates from steps 922-926 to estimate a time to crash (TTC) value. For example, the collision avoidance system may determine that a collision is impending in ten seconds, based on the locations and headings of the local and remote vehicles.

At step 930, the collision avoidance system may also estimate a time to stop (TTS) value. Such a value may generally take into account the reaction time of the driver and/or the stopping or maneuvering capabilities of the local vehicle.

At step 932, the collision avoidance system may determine whether or not to generate an alert based on the TTC and TTV values from steps 928-930. For example, if the difference in the TTC and TTV values does not exceed a threshold value, the system may return to step 906 of procedure 900, to evaluate another remote vehicle, if present. However, if the system determines in step 932 that an alert is to be generated, procedure 900 may continue to step 934.

At step 934, the collision avoidance system may analyze the threat classification of the remote vehicle from step 910, to determine whether the remote vehicle is located within the left threat zone relative to the local vehicle. If so, the system may generate a corresponding alert (step 940). If not, the system may determine whether the remote vehicle was classified as being in the right threat zone relative to the local vehicle (step 936). If so, the system may generate a corresponding alert (step 938).

As noted previously, portions of procedure 900 may be performed iteratively, to evaluate multiple remote vehicles. For example, procedure 900 may cycle through the list of remote vehicles until a determination is made in step 942 that no more remote vehicles are left in the list for analysis. When this occurs, procedure 900 may continue on to step 944 and end. Otherwise, procedure 900 may return from step 942 to step 906 and analyze the next remote vehicle in the list.

It should be noted that some or all of the steps of procedures 500-600 and 800-900 may be optional and that the steps depicted in FIGS. 5-6 and 8-9C are merely examples. Certain other steps may be included or excluded from procedures 500-600 and 800-900 as desired, according to the teachings herein. Further, while a particular ordering of steps is shown in FIGS. 5-6 and 8-9C, this ordering is merely illustrative and any suitable arrangement of the steps may be utilized without departing from the scope of the embodiments herein.

Advantageously, the techniques described herein provide a number of benefits over existing vehicle safety system. In particular, a collision avoidance system is disclosed herein that uses vehicle to vehicle (V2V) communications to detect potential collision threats with other vehicles. The system may also combine map data with the V2V data, to further refine the threat assessment. In some cases, the system may use the map data to detect roadway features that indicate that the paths of travel of the two vehicles will not intersect. In other cases, the map data may indicate upcoming threats that would otherwise be missed using the V2V data alone. Notably, the threat assessment may be performed locally at the host vehicle, thereby requiring smaller V2V communications (e.g., the remote vehicle may not be required to transmit its predicted path to the local vehicle).

While the embodiment of the present disclosure has been described in detail, the scope of the right of the present disclosure is not limited to the above-described embodiment, and various modifications and improved forms by those skilled in the art who use the basic concept of the present disclosure defined in the appended claims also belong to the scope of the right of the present disclosure.

What is claimed is:

1. A method, comprising:
receiving, at a controller of a local vehicle, data from a remote vehicle that indicates a location and direction of travel of a remote vehicle;
determining, by the controller, a roadway path of travel of the remote vehicle using map data and the data received from the remote vehicle;
determining, by the controller, a roadway path of travel of the local vehicle using the map data and data indicative of a location and direction of travel of the local vehicle;
determining, by the controller, whether the roadway path of travel of the local vehicle and the roadway path of travel of the remote vehicle intersect; and
providing, by the controller, an alert, in response to determining that the roadway path of travel of the local vehicle and the roadway path of travel of the remote vehicle intersect.

2. The method of claim 1, wherein determining whether the roadway path of travel of the local vehicle and the roadway path of travel of the remote vehicle intersect comprises:
identifying, by the controller, a non-intersecting roadway feature from the map data in the roadway paths of travel of the local and remote vehicles; and
suppressing, by the controller, the alert, in response to identifying the non-intersecting roadway feature.

3. The method of claim 2, wherein the non-intersecting roadway feature comprises at least one of: a roadway overpass, a roadway cloverleaf, a roadway curvature, or a roundabout.

4. The method of claim 1, wherein the data indicative of a location and direction of travel of the local vehicle comprises global positioning system (GPS) data.

5. The method of claim 1, wherein the intersecting roadway paths of travel of the local and remote vehicles comprise at least one of: a sloped entry intersection, a roadway curvature, or a sloped roadway in which the remote vehicle is stopped.

6. The method as in claim 1, wherein the data indicative of a location and direction of travel of the local vehicle is received by the controller via an Advanced Driver Assistance Systems Interface Specifications (ADASIS) message.

7. The method as in claim 1, further comprising:
identifying, by the controller, an upcoming built-up area associated with the roadway path of travel of the local vehicle; and, in response,
increasing, by the controller, a transmission power used to transmit the data regarding the location and direction of travel of the local vehicle to the remote vehicle.

8. The method as in claim 1, further comprising:
determining, by the controller, an estimated time to crash between the local and remote vehicles.

9. The method as in claim 1, wherein the alert is provided to at least one of: an electronic display, a braking system of the local vehicle, or a steering system of the local vehicle.

10. A system, comprising:
a processor; and
a memory configured to store a process executable by the processor, the process when executed by the processor operable to:
receive data from a remote vehicle that indicates a location and direction of travel of a remote vehicle;
determine a roadway path of travel of the remote vehicle using map data and the data received from the remote vehicle;
determine a roadway path of travel of a local vehicle using the map data and data indicative of a location and direction of travel of the local vehicle;
determine whether the roadway path of travel of the local vehicle and the roadway path of travel of the remote vehicle intersect; and
provide an alert, in response to determining that the roadway path of travel of the local vehicle and the roadway path of travel of the remote vehicle intersect.

11. The system of claim 10, wherein whether the roadway path of travel of the local vehicle and the roadway path of travel of the remote vehicle intersect is determined by:
identifying a non-intersecting roadway feature from the map data in the roadway paths of travel of the local and remote vehicles; and
suppressing the alert, in response to identifying the non-intersecting roadway feature.

12. The system of claim 11, wherein the non-intersecting roadway feature comprises at least one of: a roadway overpass, a roadway cloverleaf, a roadway curvature, or a roundabout.

13. The system of claim 10, further comprising:
a global positioning system (GPS) receiver, wherein the data indicative of a location and direction of travel of the local vehicle comprises data received by the GPS receiver.

14. The system of claim 10, wherein the intersecting roadway paths of travel of the local and remote vehicles comprise at least one of: a sloped entry intersection, a roadway curvature, or a sloped roadway in which the remote vehicle is stopped.

15. The system of claim 10, wherein the data indicative of a location and direction of travel of the local vehicle is received by the controller via an Advanced Driver Assistance Systems Interface Specifications (ADASIS) message.

16. The system of claim 10, wherein the process when executed is further operable to:
identify an upcoming built-up area associated with the roadway path of travel of the local vehicle; and, in response,
increase a transmission power used to transmit the data regarding the location and direction of travel of the local vehicle to the remote vehicle.

17. The system of claim 10, wherein the process when executed is further operable to:
determine an estimated time to crash between the local and remote vehicles.

18. The system of claim 10, wherein the alert is provided to at least one of: an electronic display, a braking system of the local vehicle, or a steering system of the local vehicle.

19. A tangible, non-transitory, computer-readable media having software encoded thereon, the software when executed by a processor operable to:
receive data from a remote vehicle that indicates a location and direction of travel of a remote vehicle;
determine a roadway path of travel of the remote vehicle using map data and the data received from the remote vehicle;
determine a roadway path of travel of a local vehicle using the map data and data indicative of a location and direction of travel of the local vehicle;
determine whether the roadway path of travel of the local vehicle and the roadway path of travel of the remote vehicle intersect; and
provide an alert, in response to determining that the roadway path of travel of the local vehicle and the roadway path of travel of the remote vehicle intersect.

20. The computer-readable media of claim 19, wherein whether the roadway path of travel of the local vehicle and the roadway path of travel of the remote vehicle intersect is determined by:
identifying a non-intersecting roadway feature from the map data in the roadway paths of travel of the local and remote vehicles; and
suppressing the alert, in response to identifying the non-intersecting roadway feature.
